(19) United States
(12) Patent Application Publication
(10) Pub. No.: US 2009/0051769 A1
(43) Pub. Date: Feb. 26, 2009

(54) METHOD AND SYSTEM FOR REMOTE MONITORING AND SURVEILLANCE

(75) Inventors: Wen-Yi Kuo, TAIPEI (TW); Li-Chung Chuang, SINDIAN CITY (TW); Un Pio Leong, TAIPEI (TW); Jui-Ming Yu, TAIPEI (TW); Chang-Han Wu, JHONGHE CITY (TW)

Correspondence Address: PAI PATENT & TRADEMARK LAW FIRM, 1001 FOURTH AVENUE, SUITE 3200, SEATTLE, WA, 98154, US

(73) Assignee: BANDRICH INC., SINDIAN CITY (TW)

(21) Appl. No.: 12/125,923

(22) Filed: May 23, 2008

Related U.S. Application Data
(60) Provisional application No. 60/940,366, filed on May 25, 2007.

(51) Int. Cl. H04N 7/18

(52) U.S. Cl. 348/159; 348/E07.085

(57) ABSTRACT

A system for remote monitoring and surveillance is disclosed in this invention. The system comprises a plurality of cameras, a router, and a server. The cameras are connected with the router separately through a wired or wireless communication protocol. The router is connected with the server through a wireless communication protocol. The cameras capture scenes and convert the captured scenes into a plurality of image signals. The router uses a communication protocol to connect with the cameras, and the router transmits the image signals by a first wireless communication protocol. The server receives the image signals by the first wireless communication protocol, processes the image signals to obtain first images, and displays the first images. A method for remote monitoring and surveillance is also disclosed in this invention.

### CROSS-REFERENCE TO RELATED APPLICATION

This application claims the priority benefit of U.S. Provisional Application Ser. No. 60/940,366, filed May 25, 2007, the full disclosures of which are incorporated herein by reference.

### BACKGROUND

1. Field of Invention

The present invention relates to a method and system for monitoring and surveillance. More particularly, the present invention relates to a method and system for remote monitoring and surveillance.

2. Description of Related Art

There is a strong need for both stationary and mobile remote monitoring and surveillance. For example, when an event happens, the commander in the police station has to see remotely through cameras installed on a pre-arrived police car to know what has actually happened at the event scene. In addition, the commander mentioned above also has to see remotely through different cameras installed on a pre-arrived police car to know more about the surroundings of the event scene.

Another example is cash delivery. During the cash delivery, the truck delivering cash is in danger of being robbed. Remotely monitoring the surroundings of the cash delivery truck can reduce the risk of such robberies.

For the foregoing reasons, there is a need for a new method and system for remote monitoring and surveillance.

### SUMMARY

According to one embodiment of the present invention, a system for remote monitoring and surveillance is provided. The system comprises a plurality of cameras, a router, and a server. The cameras capture scenes, convert the captured scenes into a plurality of image signals, and transmit the image signals by a communication protocol. The router builds a connection with the cameras for receiving the image signals and transmits the image signals by a first wireless communication protocol. The server builds a connection with the router for receiving the image signals by the first wireless communication protocol, processes the image signals to obtain first images, and displays the first images.

According to another embodiment of the present invention, a method for remote monitoring and surveillance is provided. The method comprises the steps of capturing scenes by a plurality of cameras. Then, converting the scenes into a plurality of image signals and using a wireless communication protocol to transmit the image signals to a server. The server processes the image signals to obtain a plurality of images. The images are then displayed on a monitor.

These and other features, aspects, and advantages of the present invention will become better understood with reference to the following description and appended claims. It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 is a system for remote monitoring and surveillance according to a first embodiment of this invention;

FIG. 2 is a system for remote monitoring and surveillance according to a second embodiment of this invention;

FIG. 3 is a system for remote monitoring and surveillance according to a third embodiment of this invention;

FIG. 4 is a system for remote monitoring and surveillance according to a fourth embodiment of this invention;

FIG. 5 is a method for remote monitoring and surveillance according to another embodiment of this invention; and

FIG. 6 is a camera control method for remote monitoring and surveillance according to another embodiment of this invention.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

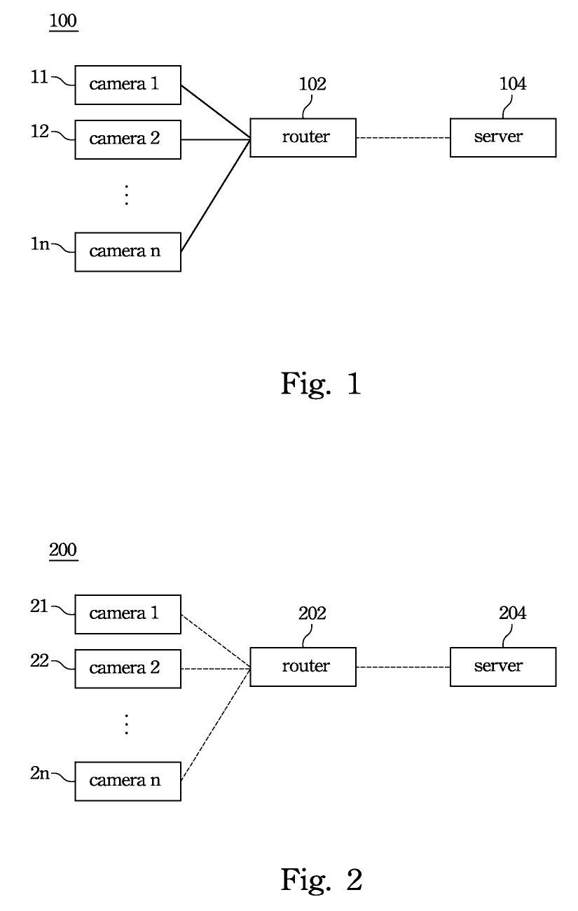

FIG. 1 is a system for remote monitoring and surveillance according to a first embodiment of this invention. Refer to FIG. 1. The system 100 comprises a plurality of cameras 11, 12, . . . and 1n, a router 102, and a server 104. Cables individually connect the cameras 11, 12, . . . and 1n to the router 102. Wherein the cable communication protocol is either Universal Serial Bus (USB), HomePlug, Power Line Communication (PLC), or combinations thereof. The router 102 is connected to the server 104 through a wireless connection. The wireless communication protocol used to establish the wireless connection between the server and the router is either 3G, 3.5G, 4G, WiMax, WiFi, HSUPA, HSPA, LTE, or combinations thereof. The cameras 11, 12, . . . and 1n feature the following automatic functions: aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.

In practice, the cameras 11, 12, . . . and 1n capture scenes, and convert the captured scenes into image signals. Then, the cameras 11, 12, . . . and 1n transmit the image signals to the router 102. The router 102 transmits the image signals to the server 104. The server 104 processes the image signals to obtain images and displays the images on a monitor.

In the first embodiment, several cameras capture scenes, convert the scenes to image signals, and transmit the image signals to a router by a wired communication protocol. The router wirelessly transmits the image signals to a server using one of the previously specified wireless communication protocols. The server processes the image signals to obtain images and displays the images on a monitor.

FIG. 2 is a system for remote monitoring and surveillance according to a second embodiment of this invention. Refer to FIG. 2. The system 200 comprises a plurality of cameras 21, 22, . . . and 2n, a router 202, and a server 204. The cameras 21, 22, . . . and 2n are wirelessly connected with the router 202 using short-ranged wireless communication protocol separately. Wherein, the short-range wireless communication protocol is either WiFi (802.11 series—802.11g, 802.11b, 802.11a, 802.11n etc.), Bluetooth, Ultra-wideband (UWB), ZigBee, or combinations thereof.

The router 202 is connected to the server 204 through a wireless connection. The wireless communication protocol used to establish the wireless connection between the server 204 and the router 202 is either 3G, 3.5G, 4G, WiMax, WiFi, HSUPA, HSPA, LTE, or combinations thereof. The cameras 21, 22, . . . and 2n feature the following automatic functions: aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.

In practice, the cameras 21, 22, . . . and 2n capture scenes, and convert the captured scenes into image signals. Then, the cameras 21, 22, . . . and 2n transmit the image signals to the router 202. The router 202 transmits the image signals to the server 204. The server 204 processes the image signals to obtain images and displays the images on a monitor.

In the second embodiment, several cameras capture scenes, convert the scenes to image signals, and wirelessly transmit the image signals to a router using a wireless communication protocol. The server processes the image signals to obtain images and displays the images on a monitor.

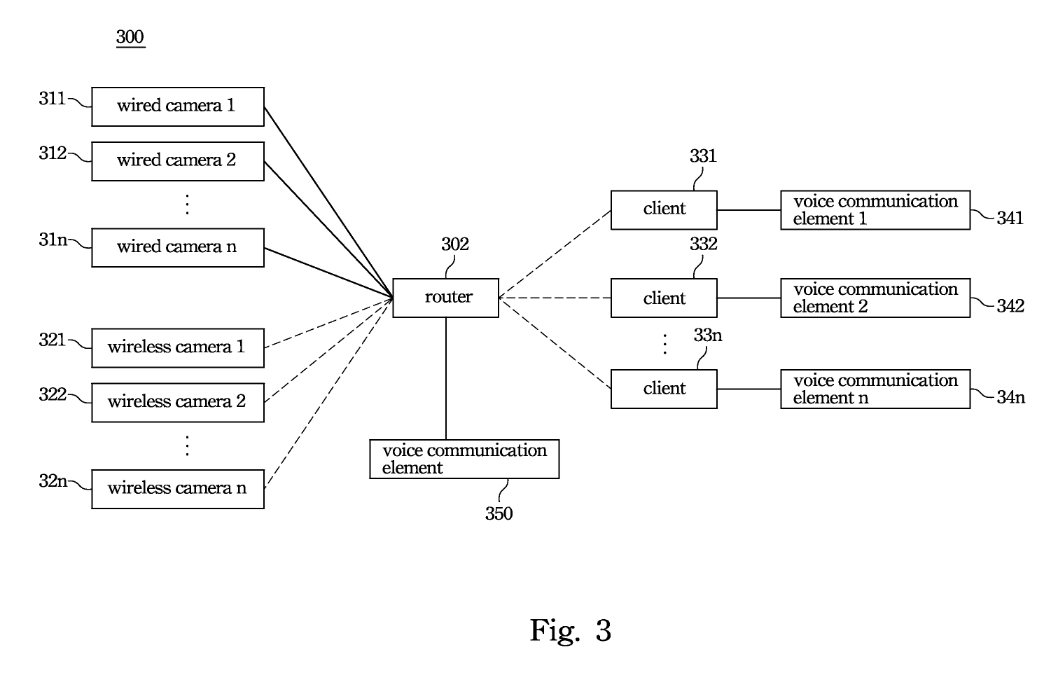

FIG. 3 is a system for remote monitoring and surveillance according to a third embodiment of this invention. Refer to FIG. 3. The system 300 comprises a plurality of wired cameras 311, 312, . . . and 31n, a plurality of wireless cameras 321, 322, . . . and 32n, a plurality of clients 331, 332, . . . and 33n, a plurality of voice communication elements 341, 342, . . . 34n, 350 and a router 302. The wired cameras 311, 312, . . . and 31n are connected with the router 302 through wires using a wired cable communication protocol. Wherein the wired cable communication protocol is either Universal Serial Bus (USB), HomePlug, Power Line Communication (PLC), or combinations thereof. The cameras 321, 322, . . . and 32n are wirelessly connected with the router 302 using short-ranged wireless communication protocol separately. Wherein, the short-ranged wireless communication protocol is either WiFi (802.11 series—802.11g, 802.11b, 802.11a, 802.11n etc.), Bluetooth, Ultra-wideband (UWB), ZigBee, or combinations thereof. The router 302 is connected to the clients 331, 332, . . . and 33n through a wireless connection. The wireless communication protocol used to establish the wireless connection between the clients 331, 332, . . . and 33n and the router 302 is either 3G, 3.5G, 4G, WiMax, WiFi, HSUPA, HSPA, LTE, or combinations thereof. The voice communication elements 341, 342, . . . 34n connects to the clients 331, 332, . . . and 33n respectively. The voice communication element 350 connects to the router 302. The wired cameras 311, 312, . . . and 31n and the wireless cameras 321, 322, . . . and 32n feature the following automatic functions: aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate. The voice communication elements 341, 342, . . . 34n, 350 are used for voice communication between each other. Wherein, each of the voice communication elements 341, 342, . . . 34n, 350 comprises a microphone and a speaker.

In practice, the wired cameras 311, 312, . . . and 31n and the wireless cameras 321, 322, . . . and 32n capture scenes, and convert the captured scenes into image signals. Then, the wired cameras 311, 312, . . . and 31n and the wireless cameras 321, 322, . . . and 32n transmit the image signals to the router 302. The router 302 transmits the image signals to the clients 331, 332, . . . and 33n respectively. The clients 331, 332, . . . and 33n process the image signals to obtain images and display the images.

In the third embodiment, several cameras capture scenes, convert the scenes to image signals, and transmit the image signals to a router. Wherein the image signals are transmitted to the router through a combination of a wired communication protocol and a wireless communication protocol. The router transmits the image signals to several clients by a wireless communication protocol. Besides, several voice communication elements are used for voice communication between the router and the clients.

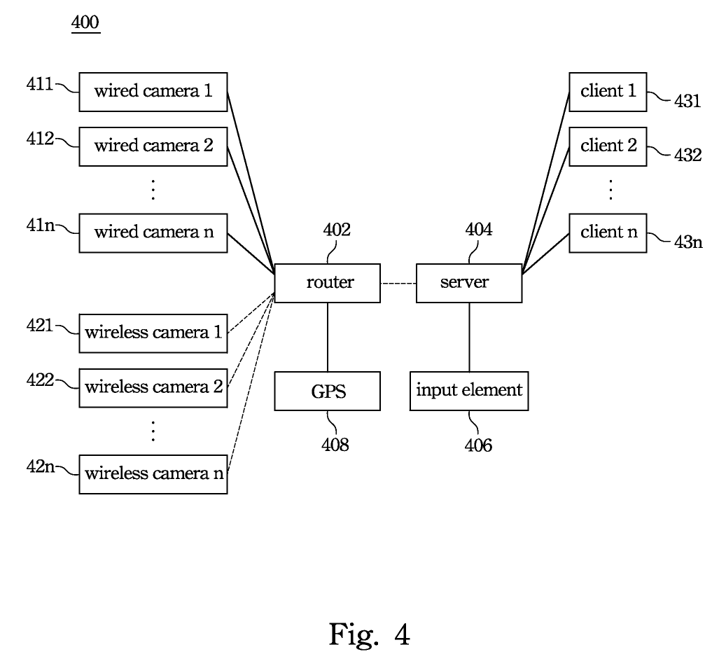

FIG. 4 is a system for remote monitoring and surveillance according to a fourth embodiment of this invention. Refer to FIG. 4. The system 400 comprises a plurality of wired cameras 411, 412, . . . and 41n, a plurality of wireless cameras 421, 422, . . . and 42n, a plurality of clients 431, 432, . . . and 43n, a router 402, a server 404, an input element 406, and a Global Positioning System (GPS) 408. Wherein, the clients 431, 432, . . . and 43n are computers, personal digital assistants (PDA), mobile phones, or handheld devices. Cables individually connect the cameras 411, 412, . . . and 41n to the router 402. Wherein the wired cable communication protocol is either Universal Serial Bus (USB), HomePlug, Power Line Communication (PLC), or combinations thereof. The cameras 421, 422, . . . and 42n are wirelessly connected with the router 402 using short-ranged wireless communication protocol separately. Wherein, the short-ranged wireless communication protocol is either WiFi (802.11 series—802.11g, 802.11b, 802.11a, 802.11n etc.), Bluetooth, Ultra-wideband (UWB), ZigBee, or combinations thereof. The router 402 is connected to the server 404 through a wireless connection. The wireless communication protocol used to establish the wireless connection between the server and the router is either 3G, 3.5G, 4G, WiMax, WiFi, HSUPA, HSPA, LTE, or combinations thereof. The clients 431, 432, . . . and 43n are connected to the server 404 through a network. Wherein the clients 431, 432, . . . and 43n are in an access-permitted client list, which is stored in the server 404. The input element 406 is connected with the server 404. The GPS 408 is connected with the router 402.

In practice, the wired cameras 411, 412, . . . and 41n and the wireless cameras 421, 422, . . . and 42n capture scenes, and convert the captured scenes into image signals. Then, the wired cameras 411, 412, . . . and 41n and the wireless cameras 421, 422, . . . and 42n transmit the image signals to the router 402. The router 402 transmits the image signals to the server 404. Besides, the router 402 also processes the image signals to obtain and display the images. The server 404 records the image signals, processes the image signals to obtain images, and displays the images. In addition, the server 404 transmits the image signals to the clients 431, 432, . . . and 43n. The clients 431, 432, . . . and 43n process the image signals to obtain images and display the images.

A plurality of control signals are input through the input element 406 to the server 404. The server 404 transmits the control signals to the router 402 to make the router utilize functions of the wired cameras 411, 412, . . . and 41n and the wireless cameras 421, 422, . . . and 42n. The function of the wired cameras 411, 412, . . . and 41n and the wireless cameras 421, 422, . . . and 42n comprise: aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.

The GPS 408 produces a plurality of positioning signals and transmits to the router 402. Wherein the positioning signals stand for real-time positions of the router 402. The router 402 transmits the positioning signals to the server 404. The server 404 processes the positioning signals to obtain the real-time position of the router 402.

In the fourth embodiment, several cameras capture scenes, convert the scenes to image signals, and transmit the image signals to a router. Wherein the image signals are transmitted to the router by combination of a wired communication protocols and wireless communication protocols. The router transmits the image signals to a server by a wireless communication protocol. The server records the image signals, processes the image signals to obtain images, and displays the images on a monitor. The server also transmits image signals to several permitted clients. The clients process the image signals to obtain images and display the images. Besides, the router also processes the image signals to obtain images and display the images. An input element is used for inputting the control signals to make the router utilize functions of the cameras. A GPS produces positioning signals of the router.

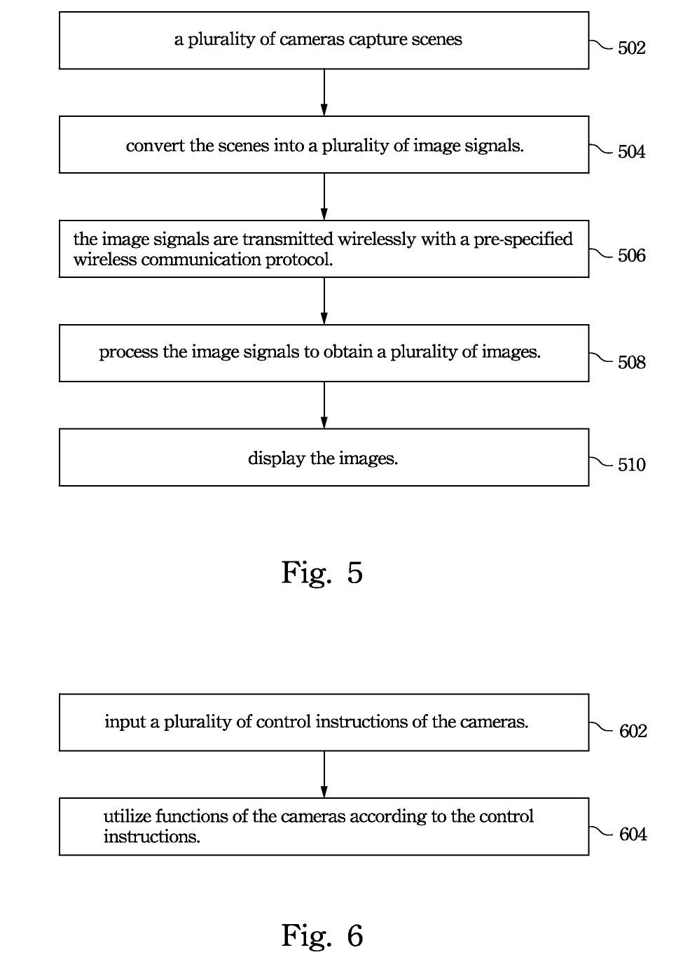

FIG. 5 is a method for remote monitoring and surveillance according to another embodiment of this invention. The method begins with the step 502 where a plurality of cameras capture images of scenes. In the next step 504, convert the scenes into a plurality of image signals. Wherein the image signals have small file size with high video quality. Then, in the step 506, the image signals are transmitted wirelessly with a pre-specified wireless communication protocol. Wherein, the wireless communication protocol is 3G, 3.5G, 4G, WiMax, WiFi, HSUPA, HSPA, LTE, or combinations thereof. In the step 508, process the image signals to obtain a plurality of images. In the next step 510, display the images.

FIG. 6 is a camera control method for remote monitoring and surveillance according to another embodiment of this invention. The method begins with the step 602 in which input a plurality of control instructions of the cameras. In the next step 604, utilize functions of the cameras according to the control instructions. Wherein the functions of the cameras comprising aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.

Although the present invention has been described in considerable detail with reference certain embodiments thereof, other embodiments are possible. For example, the system comprises a plurality of servers. Besides, the system comprises several input elements connected to at least one of a router, a server and clients to input control signals to utilize functions of cameras. Therefore, their spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

Several different advantages exist with these and other embodiments. The system and method can remotely monitor scenes on a server by several cameras. Besides, several permitted clients can monitor the scenes through the transmission of image signals of the server. The cameras can be controlled remotely to reach better effect of monitoring. The GPS can position the router to make better understanding of the scenes.

What is claimed is:

1. A system for remote monitoring and surveillance, comprising:
a plurality of cameras for capturing scenes converting the captured scenes into a plurality of image signals, and transmitting the image signals by a communication protocol;
a router building a connection with the cameras for receiving the image signals and transmitting the image signals by a first wireless communication protocol; and
a server building a connection with the router for receiving the image signals by the first wireless communication protocol, processing the image signals to obtain first images, and displaying the first images.

2. The system of claim 1, wherein the communication protocol is a wired communication protocol or a second wireless communication protocol.

3. The system of claim 2, wherein the wired communication protocol is Universal Serial Bus (USB), HomePlug, Power Line Communication (PLC), or combinations thereof.

4. The system of claim 2, wherein the second wireless communication protocol is WiFi, Bluetooth, Ultra-wideband (UWB), ZigBee, or combinations thereof.

5. The system of claim 1, wherein the first wireless communication protocol is 3G, 3.5G, 4G, WiFi, WiMax, HSUPA, HSPA, LTE, or combinations thereof.

6. The system of claim 1, further comprising a plurality of clients, wherein the server transmits the image signals to the clients through network.

7. The system of claim 1, further comprising a plurality of clients, wherein the router transmits the image signals to the clients by a first wireless communication protocol.

8. The system of claim 6 or claim 7, wherein the clients converting the image signals to second images and displaying the second images.

9. The system of claim 6 or claim 7, further comprising a plurality of voice communication elements connected to the router and at least one of the server and the clients for voice communication between each other.

10. The system of claim 6 or 7, further comprising at least an input element connected with at least one of the router, the server, and the clients to input a plurality of control instructions of the cameras, wherein functions of the cameras can be utilized according to the control instructions of the cameras

11. The system of claim 10, wherein the functions of the cameras comprising aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.

12. The system of claim 1, wherein the router converting the image signals into a plurality of third images and displaying the third images.

13. The system of claim 1, wherein the server records the image signals.

14. The system of claim 1, further comprising a global positioning system (GPS) connected with the router for producing a plurality of positioning signals, wherein the positioning signals stand for real-time positions of the router;

15. The system of claim 14, wherein the router transmits the positioning signals to the server by the first wireless communication protocol and the server processes the positioning signals to obtain the real-time positions of the router.

16. The system of claim 1, wherein the router triggers transmissions of the image signals by the first wireless communication protocol when a moving scene is detected.

17. A method for remote monitoring and surveillance, comprising the steps of:
a plurality of cameras capturing scenes;
converting the scenes into a plurality of image signals;
transmitting the image signals to a server by a wireless communication protocol;
the server processing the image signals to obtain a plurality of images; and
displaying the images.

18. The method of claim 17, wherein the communication protocol is 3G, 3.5G, 4G, WiFi, WiMax, HSUPA, HSPA, LTE, or combinations thereof.

19. The method of claim 17, further comprising the steps of:
inputting a plurality of control instructions of the cameras;
utilizing functions of the cameras according to the control instructions;

20. The method of claim 19, wherein the functions of the cameras comprising aperture adjustment, shutter adjustment, exposure adjustment, focus adjustment, white balance adjustment, night-vision mode, zoom-in, zoom-out, turning on lights of the cameras, switching to one of the cameras, rotating one of the cameras, or rotating the image signals, which makes the first images rotate.
